(19) United States
(12) Patent Application Publication
(10) Pub. No.: US 2011/0112718 A1
(43) Pub. Date: May 12, 2011

(54) ON-BOARD NETWORK SYSTEM OF A MOTOR VEHICLE AND PROCESS FOR OPERATING THE ON-BOARD NETWORK SYSTEM

(75) Inventors: Stefan CLAUS, Muenchen (DE); Christian Süss, Vierkirchen (DE)

(73) Assignee: Bayerische Motoren Werke Aktiengesellschaft, Muenchen (DE)

(21) Appl. No.: 12/951,939

(22) Filed: Nov. 22, 2010

Related U.S. Application Data
(63) Continuation of application No. PCT/EP2009/003257, filed on May 7, 2009.

(30) Foreign Application Priority Data
May 23, 2008 (DE) 10 2008 024 979.3

(51) Int. Cl. G06F 19/00

(52) U.S. Cl. 701/35; 701/29

(57) ABSTRACT

A desired-status storage device in which details concerning control devices is provided in an on-board network system and the data statuses present in each of these control devices are stored. A retrieval device addresses the control devices provided in the on-board network system and retrieves the data statuses in each case actually present in the concerned control device, and stores the result of the retrieval. A comparison device compares the data statuses stored in the desired-status storage device with the data statuses determined by the retrieval device. In the event of a deviation of the data statuses, a measures device initiates at least one measure, particularly, if required, a measure which ensures a safe driving operation of the motor vehicle.

### CROSS REFERENCE TO RELATED APPLICATIONS

This application is a continuation of PCT International Application No. PCT/EP2009/003257, filed May 7, 2009, which claims priority under 35 U.S.C. §119 from German Patent Application No. DE 10 2008 024 979.3, filed May 23, 2008, the entire disclosures of which are herein expressly incorporated by reference.

### BACKGROUND AND SUMMARY OF THE INVENTION

The invention relates in general to an on-board network system of a motor vehicle having control devices which communicate with one another by way of at least one data bus, according to Claim 1.

In the case of known vehicles, the so-called vehicle order is filed centrally in a control device and redundantly as a backup in a further control device in the course of the production of the vehicle. By means of product description codes (e.g., model keys, paint and upholstery codes, optional/packet equipment codes, and additional information, such as the point in time of production, the factory and the service codes), the vehicle order describes the configuration of the vehicle and should always correspond to the current equipment status of the vehicle. The vehicle order is utilized by vehicle-external diagnostic, programming and coding systems, particularly in the shop. In the following, this information and all additional information describing the configuration of a vehicle will be called “configuration data” of the vehicle.

In addition to this central configuration information, control-device-specific information (e.g., the identification of the hardware or the hardware variant of the software, its data, its coding of information concerning the manufacturer, the serial number of the control device, the order subject number of the control device, as well as the chassis number of the vehicle) is filed in the respective control device. In the following, this information and all additional information identifying the individual control devices of the vehicle are called “logistic data” of the corresponding control device.

Different vehicles with different logistics data may have the same configuration data.

It is an object of the present invention to improve the reliability of known on-board network systems.

This object may achieved by an on-board network system according to the invention and a process according to the invention for operating the on-board network system according to the invention. Advantageous further developments of the invention are the object of the respective dependent claims.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 depicts one embodiment of a motor vehicle having an on-board network system configured in accordance with the principles of the invention; and

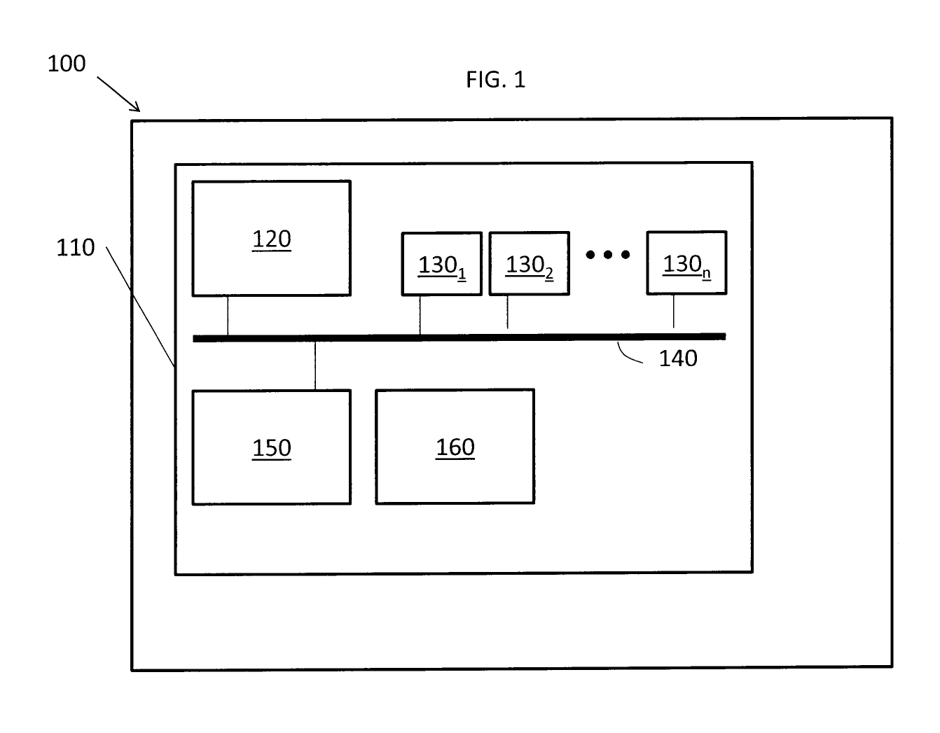

FIG. 2 depicts one embodiment of a process for carrying out one or more aspects of the invention.

### DETAILED DESCRIPTION OF THE DRAWINGS

A desired-status storage device 120 is provided in the case of the on-board network system 110 of a motor vehicle 100 according to the invention having control devices 130₁₋ₙ which communicate with one another by way of at least one data bus 140.

Details concerning control devices 130₁₋ₙ provided in the on-board network system and the data statuses present in each of these control devices 130₁₋ₙ are stored in the desired-status storage device 120. This preferably takes place in the form of a desired-status list.

A retrieval device 150 addresses the control devices 130₁₋ₙ provided in the on-board network system 110 by way of the at least one data bus 140 and retrieves the data statuses in each case actually present in the concerned control device. The result of the retrieval is preferably stored by the retrieval device 150. The retrieval preferably takes place by means of a diagnostic protocol, and the result of the retrieval is stored particularly in the form of an actual-status list.

A comparison device 160 compares the data statuses stored in the desired-status storage device 120 with the data statuses determined by the retrieval device 150 and, in the event of a deviation of the data statuses, a measures device (not shown) initiates at least one measure, particularly, if required, a measure which ensures a safe driving operation of the motor vehicle.

By means of the measures according to the invention, it can be reliably determined whether changes have been made at the on-board network system 110. These changes can be assessed with respect to their compatibility effects and safety effects, and measures for avoiding impairments can be derived from the result of the assessment.

In an embodiment of the invention, it is provided that the desired-status storage device 120 is provided in a control device that has a data-technically external vehicle access, for example, particularly an access by Ethernet or CAN.

According to an aspect of the invention, the configuration data and/or logistics data of the control devices 130₁₋ₙ, preferably of all control devices, are stored in the desired-status storage device. The storage takes place particularly after the completion of the vehicle 100 in the vehicle manufacturer's plant or after a repair in a specialized workshop.

According to an aspect of the invention, it is provided that the configuration data includes the vehicle order which describes the configuration and the current equipment status of the concerned vehicle particularly by means of product description codes, such as model keys, paint and upholstery codes, optional or packet equipment codes, the point in time of production as well as possibly additional factory and service codes.

In an embodiment of the invention, it is provided that the logistics data of the control devices 130₁₋ₙ include their control-device-specific information, such as an identification of the hardware or hardware variant, of the software, of the data, the coding, of the manufacturers, the serial number, the order subject number, and/or the chassis number of the concerned vehicle.

In an embodiment of the invention, it is provided that the configuration and/or logistics data of the control devices 130₁₋ₙ can be stored in the desired-status storage device 120 only after an authorization check.

It is further provided that the history of changed configuration and/or logistics data of the control devices 130₁₋ₙ is stored in the desired-status storage device 120. As a result, it becomes possible, for example, to return the on-board network system 110 in a targeted manner to an earlier software and/or hardware status.

It is further provided that the data statuses stored in the desired-status storage device 120 are regularly compared during the operation of the vehicle 100 with the data statuses determined by the retrieval device 150.

It is further provided that the configuration and/or logistics data also include data which relate to non-electric/electronic vehicle equipment, such as a roof rack, a child seat, a ski bag or a cup holder.

In an embodiment of the invention, the configuration and/or logistics data stored in the desired-status storage device define which assigned parts of an electronic operating instruction are displayed to the driver, particularly in the event of an error.

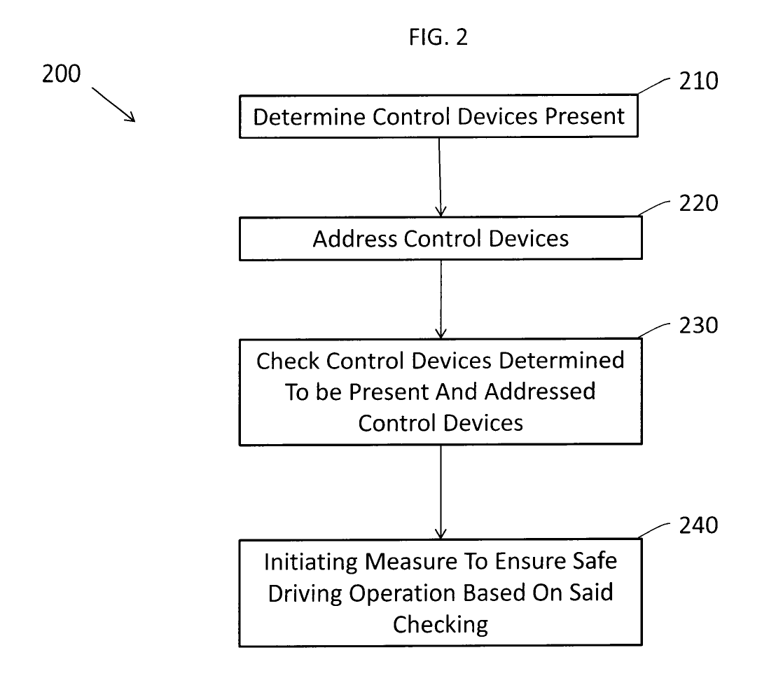

With reference now to FIG. 2, a process 200 according to the invention for operating such an on-board network system is characterized in that it is determined in a first step 210 which control devices are present in the on-board network and which logistics and/or configuration data are stored in the respective control device. It can preferably also be determined by way of which at least one data bus the respective control device can be accessed, in which case the determined control devices, the determined logistics and/or configuration data and, if required, the information concerning the accessibility are preferably stored by means of routing information in a reference list.

In a second step 220, each control device provided in the on-board network is addressed by way of all existing data buses, and the logistics and/or configuration data stored in the respective control device are retrieved. The retrieval preferably takes place by way of an on-board network diagnostic protocol, and the result of the retrieval is stored in the form of an actual list.

In a third step 230, it is checked whether each of the control devices determined in the first step could be addressed in the second step, and/or whether one or more additional control devices not determined in the first step could be addressed in the second step, and/or whether the logistics and/or configuration data determined in the first step for the respective control device correspond to those determined in the second step.

In a fourth step 240, in the event of a deviation between the control devices determined in the second and in the third step and/or the logistics and/or configuration data determined in the second and third step, at least one measure is initiated, particularly, if required, a measure which ensures a safe driving operation of the motor vehicle.

In an embodiment of the process according to the invention, the implementation of the first step 210 is initiated after the completion of the vehicle in the vehicle manufacturer's plant or after the repair of the vehicle in a specialized shop, particularly after an authorization check.

In an embodiment of the process according to the invention, it is provided that the implementation of steps two 220, three 230 and four 240 is initiated during the operation of the vehicle, particularly when the vehicle engine is started or periodically after a certain time interval.

In a further development of the process according to the invention, it is provided that those control devices which have not responded in the second step 220, additionally are addressed directly by means of a diagnostic protocol. If they can respond, the logistics and/or configuration data stored in the respective control device will be retrieved.

In an embodiment of the invention, the deviation between the control devices determined in the second 220 and in the third step 230 and/or the logistics and/or configuration data determined in the second 220 and in the third step 230 is evaluated by a predefined sequence-controlled compatibility check and/or a risk evaluation. As a function of the evaluation, a measure will be initiated (240), such as, in particular, no action, an entry into an error memory, an entry into the logistics and/or configuration data of the corresponding control device, a message to the driver, a message to dependent control devices or functions, the deactivation of one or more functions, the ignoring of certain information on one or more of the data buses and/or the prevention of an engine start.

In an embodiment of the invention, it is provided that one or more on-board network users, such as software functions and/or control devices, retrieve data from the central data memory or the desired-status storage device for the purpose of utilization.

Several examples of the utilization of configuration data stored in the desired-status storage device and relations by software functions and/or control devices are:
a Flexray module provided in the on-board network system, preferably in a central gateway (ZGW) of the on-board network, checks by means of the topology information stored in the desired-status storage device which Flexray connections at the ZGW should be occupied and which are actually occupied. The unoccupied Flexray connections are switched off in order to prevent electrical interferences;
a Master Security Module (MSM) provided in the on-board network system, preferably in the ZGW, requests a list of all vehicle-security-relevant control devices from the desired-status storage device; and
a diagnostic master provided in the on-board network system retrieves from the desired-status storage device a list of all control devices capable of actively sending the contents of their error memories to the central error memory.

Electronic operating instructions provided in the on-board network system insert in the head unit or the instrument cluster of the vehicle only the information actually relevant in view of the concrete configuration data of the concerned vehicle (no misleading operating information for the optional equipment not built into the concrete vehicle).

A diagnosis-routing function provided in the on-board network system, preferably in the ZGW, sets up the corresponding routing tables on the basis of the topology information stored in the desired-status storage device.

A function for personalizing adjustments at the vehicle (PIA), such as the seat position and mirror position, the personal radio stations, telephone numbers, etc., provided in the on-board network system, establishes a list of those control devices which contain personalized data on the basis of corresponding information in the desired-status storage device.

An “energy control” function provided in the on-board network system switches off the not required functions/consuming devices by means of corresponding configuration data in the desired-status storage device, as, in particular, the energy consumption of the corresponding control device and the “functional dependence” and “function hierarchy” relations.

An intelligent diagnostic function provided in the on-board network system evaluates the effect of certain errors on the availability of vehicle functions by means of error events and the relationships “functional dependence” and “function hierarchy” stored in the desired status storage device.

It is further provided that one or more on-board network users, such as software functions and/or control devices, are notified of changes in the central data memory or of the desired-status storage device.

After the notification of the above-mentioned on-board network users, the latter utilize in the above-described manner the changed configuration data and relations, which were stored in the desired-status storage device. The on-board network users may no longer have to cyclically retrieve the configuration data and relations for determining possible changes but are notified in the event of a data change and will then adjust the data once.

In the following, various aspects of the invention will be described in detail by means of one or more embodiments.

Configuration and logistics data concerning the entire on-board network may be stored at the central location, preferably in a control device with an external vehicle access, for example, by Ethernet or CAN. Such data may include, for example, the vehicle order, configuration data of the control devices and information concerning the built-in sensors and actuators. Likewise, identification information may also be stored in such a central location. Identification information may include, for example, the chassis number, service data, technical data, information concerning the data buses, information concerning software and hardware installation conditions of each control device, overlapping information concerning the software and hardware installation condition of the entire vehicle, the serial numbers of the individual control devices, information concerning the power management (e.g., whether a generator or a consuming device is involved), electrical consumption, prioritization with respect to switching-off, information concerning technical possibilities of control devices and buses (e.g., transmission bandwidths, supported audio/video codecs, etc.), or information concerning the compatibility of functions and control devices. Furthermore, configuration and logistics data for non-electric/electronic equipment may be filed, for example, for a roof rack, a ski bag, a cup holder, etc.

By providing a corresponding sequence control in the vehicle, the on-board network system permits the management of functions available in the vehicle, i.e. on the control devices, in order to, for example, support the dynamic logging-on/logging-off and requesting of functions by on-board network users.

In addition, relations (e.g., the physical connection, functional dependencies, etc.) between the different entities, particularly the control devices, are preferably centrally stored. The relations permit a more extensive analysis of the on-board network system, for example, an analysis of the on-board network topology, or of diagnosis routing tables.

In one or more embodiments, data may be imported and read-out after an authorization check by way of the data-technically external vehicle access of the central control device.

This data status, which was transmitted to the central control device by means of an external entity (e.g., an authorized vehicle repair shop, manufacturer's plant, trusted control device within the vehicle) and is not changed in the driving operation, is called a desired-status. In contrast, the actual status is the database that was generated at an arbitrary point in time during the vehicle operation by retrieving the on-board network users, particularly control devices or onboard systems, by way of the vehicle buses. In addition to this retrieval of the control devices, i.e. the retrieval of the on-board systems with respect to configuration or logistics data (pull principle), the latter themselves can file corresponding data in the central configuration and logistics data memory (push principle) and can also retrieve them.

In order to be able to trace configuration and logistics changes in the vehicle, changes are stored in a central control device, so that, for any point in time, the on-board network configuration valid at this point in time can be reconstructed by means of these historical data statuses. These historical data statuses can also be utilized in order to roll back a vehicle to a defined earlier status, for example, within the scope of programming.

On-board network users/functions, which are dependent on configuration or logistics data stored in the central control unit, can be notified in the event of changes of the data status and can thereby access precisely the required information in a dedicated manner.

The on-board network system of this embodiment has different optical and electrical data buses which are mutually connected by way of the central control device. This central control device is used, among other things, as an access to the vehicle for service, plant and other communication diagnostic systems. The data buses are Ethernet or CAN data buses. It is not absolutely necessary to connect the central control device directly to all data buses built into the vehicle but, in this manner, the parallel retrieval of the configuration and logistics data from the control devices can be optimized with respect to the bus loading and the retrieval duration.

For ensuring the compatibility and reliability of the on-board network system, deviations between the desired status and the actual status are determined in the embodiment by means of the logistics and configuration information stored in the central control device. This may be achieved according to the following exemplary process:

In this example process, the communication between the control devices in the on-board network system takes place on the basis of a diagnostic protocol for the vehicle. However, the use of another protocol, such as the Ethernet protocol or the CAN protocol is also conceivable.

In the embodiment, the process is started by two events respectively. In the first case, an external entity (e.g., an authorized vehicle shop, an entity in the manufacturer's plant, a trusted control device within the vehicle, etc.) initiates the implementation of the process by triggering the central control device by way of its data-technically external vehicle access.

In the second case, the process is started vehicle-internally by the central control unit when a certain event occurs, as, for example, after the start of the engine or periodically after a predefined time interval.

After the start of the process according to one or more embodiments, the following actions may take place in the central control device:

a list may be generated of all control devices available according to the desired status (desired-status list), including the routing information by way of which data buses the respective control device can be accessed in order to optimize the retrievals with respect to the retrieval time and the bus loading;

by way of broadcasts or “multi-addressing” on all required data buses, the logistics and configuration data of the on-board network users, particularly the control devices, may be retrieved by means of the diagnostic protocol;

should individual control devices from the reference list not have responded to the broadcasts, the data of these control devices may be retrieved by means of diagnostic protocols by additionally directly addressing the control devices; and

subsequently, a list (actual-status list) of all actually existing control devices including logistics and configuration information may be generated from the responses to the logistics queries. This list can also be read out by authorized external entities and internal functions.

The following results may be obtained from a comparison between the control devices available according to the desired status and according to the actual status:

Case a): The concerned control device has not responded but is present in the on-board network system according to the desired status:

In this case, the concerned control device may be considered to have failed or not installed.

Case b): The concerned control device has responded to broadcast, but is not listed in the desired-status list:

The concerned control device may be considered to be additionally installed in an unauthorized manner.

Case c): The concerned control device has responded and is listed in the desired-status list. However, the logistics and configuration data according to the actual-status list differ from those of the desired-status list;

for example, different hardware serial numbers, different software versions, different configuration parameters, different coding, etc.

The concerned control device is considered to be exchanged, programmed or configured in an unauthorized manner.

The above-mentioned results are indicated in the actual-status list for the concerned control device. One or more suitable measures, which ensure a safe driving operation of the motor vehicle—even in the case of an incompatible configuration—are derived from the concrete result—. For this purpose, a corresponding sequence control is provided for a compatibility and risk evaluation in the central control unit. Conceivable measures would, for example, be: an entry in the error memory of the concerned control device which can later be read out by the service in the shop; an entry into the logistics or configuration data, a message to the driver, a message to dependent control devices/functions, a deactivation of certain functions, the ignoring of certain information on a data bus and/or the preventing of the start of the engine. In individual cases, it may also be advantageous not to initiate any measure.

In the case of the process of the embodiment, it is provided that the desired status can be stored in the central control device only by trustworthy entities (service, factory, etc.) and is protected against manipulation (for example, by signature, encryption). Furthermore, it is advantageous for authorized changes at the on-board network (hardware and software changes, configuration changes) to be documented in the desired status.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An on-board network system of a motor vehicle having control devices configured to communicate with one another by way of at least one data bus, the on-board network system comprising:
a desired-status storage device containing details concerning said control devices and desired data statuses for said control devices in the form of a desired-status list;
a retrieval device configured to address said control devices by way of the at least one data bus and to retrieve actual data statuses actually present in each of the control devices by means of a diagnostic protocol, wherein a result of retrieving said actual data statuses is stored in the form of an actual-status list;
a comparison device configured to compare the desired data statuses stored in the desired-status storage device with the actual data statuses determined by the retrieval device; and
a measures device which, in the event of a different between the desired data statuses and the actual data statuses, initiates at least one measure which, if required, ensures a safe driving operation of the motor.

2. The on-board network system according to claim 1, wherein the desired-status storage device is provided in a control device that has a data-technically external vehicle access by one of Ethernet or CAN.

3. The on-board network system according to claim 1, wherein at least one of configuration data and logistics data of the control devices are stored in the desired-status storage device.

4. The on-board network system according to claim 3, wherein the configuration data includes the vehicle order describing the configuration and the current equipment status of the vehicle.

5. The on-board network system according to claim 3, wherein the logistics data includes control-device-specific information.

6. The on-board network system according to claim 3, wherein at least one of the configuration and logistics data is stored in the desired-status storage device only after an authorization check.

7. The on-board network system according to claim 3, wherein a history of at least one of changed configuration data and logistics data of the control devices is stored in the desired-status storage device.

8. The on-board network system according to claim 1, where in the desired data statuses stored in the desired-status storing device are periodically compared during the operation of the vehicle with the actual data statuses determined by the retrieval device.

9. The on-board network system according to claim 3, wherein at least one of the configuration data and logistics data further includes data which relates to non-electric/electronic vehicle equipment.

10. The on-board network system according to claim 3, wherein at least one of the configuration data and logistics data further define which assigned parts of an electronic operating instruction are displayed to the driver in the event of an error.

11. A method for operating an on-board network of a motor vehicle having control devices configured to communicate with one another by way of at least one data bus, the method comprising the acts of:
determining which control devices are present in the on-board network and which logistics data and configuration data are stored in each of the respective control devices;
addressing each control device provided in the on-board network and retrieving at least one of the logistics data and configuration data stored in the respective control devices, the retrieval preferably taking place by way of an on-board network diagnostic protocol, and the result of the retrieval being stored in the form of an actual list;
checking whether each of the control devices determined to be present in the on-board network could also be addressed, and whether one or more additional control devices not previously determined to be present in the on-board network could be addressed, and whether the logistics data and configuration data for the determined control devices correspond to the addressed devices; and
initiating at least one measure which ensures a safe driving operation of the motor vehicle based on said checking in the event of a deviation between at least one of the determined control devices and the addressed control devices, and the logistics data and configuration data corresponding thereto.

12. The method according to claim 11, wherein the act of determining which control devices are present is performing after an authorization check and following one of the completion of the vehicle in the vehicle manufacturer's plant and after repair of the vehicle in a specialized shop.

13. The method according to claim 11, wherein the act of checking each of the control devices is initiated during operation of the vehicle.

14. The method according to claim 11, further comprising:
additionally addressing directly at least one control device determined to be present, but which could not be addressed, by means of a diagnostic protocol; and
retrieving at least one of logistics data and configuration data stored in any control device that responds to said additional addressing.

15. The method according to claim 11, wherein said deviation is evaluated by at least one of a predefined sequence-controlled compatibility check and a risk evaluation, and wherein initiating at least one measure comprises initiating at least one of the following measures: no action, an entry into an error memory, an entry into the logistics data and/or configuration data of a corresponding control device, a message to the driver, a message to dependent control devices/functions, deactivation of one or more functions, ignoring of information on one or more of the data buses and the prevention of an engine start.
